(19) United States
(12) Patent Application Publication
(10) Pub. No.: US 2010/0111375 A1
(43) Pub. Date: May 6, 2010

(54) Method for Determining Atributes of Faces in Images

(76) Inventor: Michael Jeffrey Jones, Somerville, MA (US)

Correspondence Address: MITSUBISHI ELECTRIC RESEARCH LABORATORIES, INC., 201 BROADWAY, 8TH FLOOR, CAMBRIDGE, MA, 02139, US

(21) Appl. No.: 12/263,191

(22) Filed: Oct. 31, 2008

(51) Int. Cl. G06K 9/00

(52) U.S. Cl. 382/118

(57) ABSTRACT

A method for determining attributes of a face in an image compares each patch in the set of patches of the image of the face with a set of prototypical patches. The result of comparison is a set of matching prototypical patches. The attributes of the image of the face are determined based on the attributes of the set of matching prototypical patches.

### FIELD OF THE INVENTION

The present invention relates generally to analyzing images of faces, and more particularly to determining attributes of faces in images.

### BACKGROUND OF THE INVENTION

Although people are extremely good at recognizing attributes of faces, computers are not. There are many applications that require an automatic analysis of images to determine various attributes of the faces, such as gender, age, race, mood, expression, and pose. It would be a major commercial advantage if computer vision techniques could be used to automatically determine general attributes of faces from images.

There are several conventional computer vision methods for face analysis but all suffer from a number of disadvantages. Typical conventional methods use classifiers that must first be trained using supervised learning techniques that consume resources and time. Examples of the classifiers include boosted classifiers, support vector machines (SVMs), and neural or Baysian networks. Some of those classifiers operate on raw pixel images, while others operate on features extracted from the images such as Gabor features or Haar-like features.

Conventional Classifiers

Golomb et al. in “SEXNET: A neural network identifies sex from human faces,” Advances in Neural Information Processing Systems, pp. 572-577, 1991, described a fully connected two-layer neural network to identify gender from human face images consisting of 30×30 pixel images.

Cottrell et al., in “Empath: Face, emotion, and gender recognition using holons,” Advances in Neural Information Processing Systems, pp. 564-571, 1991, also applied neural networks for face emotion and gender recognition. They reduced the resolution of a set of 4096×4096 images to 40×40 via an auto-encoder network. The output of the network was then input to another one layer network for training and recognition.

Brunelli et al, in “HyperBF networks for gender classification,” Proceedings of the DARPA Image Under-standing Workshop, pp. 311-314, 1992, developed HyperBF networks for gender classification in which two competing radial basis function (RBF) networks, one for male and the other one for female, were trained using sixteen geometric features, e.g., pupil to eyebrow separation, eyebrow thickness, and nose width, as inputs.

Instead of using a raster scan vector of gray levels to represent face images, Wiskott et al., in “Face recognition and gender determination,” Proceedings of the International Workshop on Automatic Face and Gesture Recognition, pp. 92-97, 1995, described a system that used labeled graphs of two-dimensional views to describe faces. The nodes denote jets, which are a special class of local templates computed on the basis of wavelet transform, and the edges were labeled with distance vectors. They used a small set of controlled model graphs of males and females to encode the general face knowledge.

More recently, Gutta et al., in “Gender and ethnic classification of Face Images,” Proceedings of the IEEE International Automatic Face and Gesture Recognition, pp. 194-199, 1998, described a hybrid method, which includes an ensemble of neural networks (RBFs) and inductive decision trees.

It is desired to have a simple, yet accurate, method for determining attributes of faces in images. It is also desired to determine attributes of faces in images without explicit image training.

### SUMMARY OF THE INVENTION

It is an object of the present invention to provide a method for determining, from an image of a face, attributes of the face such as, but not limited to, gender, age, race, mood, expression, and pose.

It is a further object of the invention to provide such a method that does not require explicit or implicit training as used with most conventional face classifiers.

The main advantage of the method according to the invention is that it is simpler and more accurate than conventional solutions. The embodiments of the invention also provide a solution to the multi-class problem, when an attribute, such as age, has more than two possible values.

The method also removes the burden of training a classifier.

The invention is based on the realization that an image of a face can be well approximated by combining small regions of images of other people's faces. In other words, a face can be characterized by combining image parts of the faces, e.g., noses, eyes, cheeks, and mouths, acquired from different people. Moreover, those image parts can carry a set of attributes of the entire face. For example, an image part of a male nose is more likely to be most similar to a nose in a set of male faces than in a set of female faces.

Thus, if a nose part of an image of an unknown face is similar to a nose part in an image of a male face, then, with some degree of certainty, it could be said that the unknown face in the image is male.

Similarly, other attributes of an image of a face, like age, race, and expression, could be found by comparison with a set of patches with known attributes.

### BRIEF DESCRIPTION OF THE DRAWINGS

FIG. 1 is a flow diagram of a method for determining attributes of a face using an image acquired of the face according to embodiments of the invention;

FIG. 2 is a schematic of comparison of a patch of the image of the face with a set of prototypical patches according to the embodiments of the invention;

FIGS. 3A and 3B are partitioned images of faces according to the embodiments of the invention;

FIG. 3C is a cropped image of a face according to the embodiments of the invention; and

FIG. 4 is a flow diagram of determining an attribute of a face from attributes of matching prototypical patches according to the embodiments of the invention.

### DETAILED DESCRIPTION OF THE PREFERRED EMBODIMENT

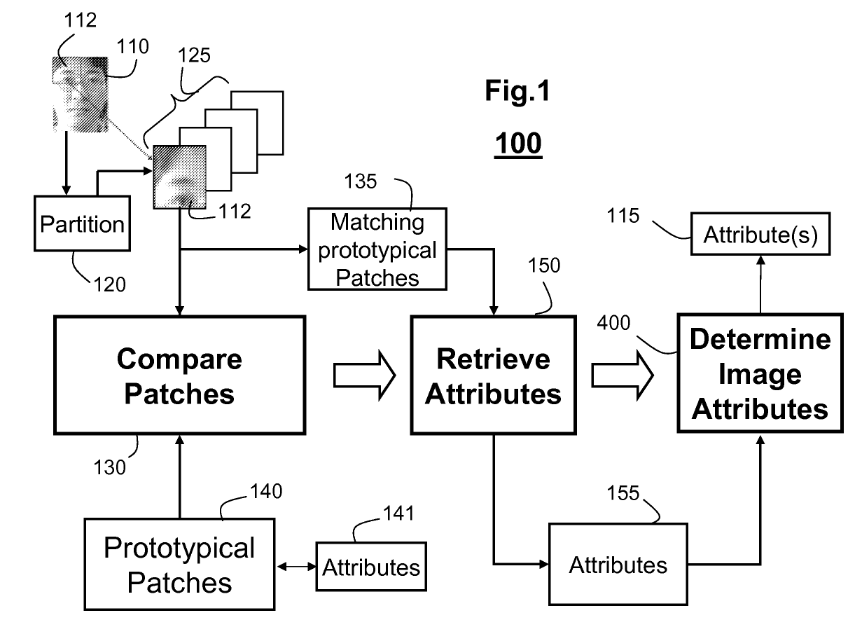

FIG. 1 shows a method 100 for determining a set of attributes 115 of a face in an input image 110 according to embodiments of this invention. The method 100 can be performed in real time. As used herein, a set of attributes can include one or more attributes.

In one embodiment, the input image 110 of the face is acquired by a camera. In other embodiments the method 100 retrieves the input image 110 from a computer readable memory (not shown), or via a network.

The input image 110 is partitioned 120 into a set of input patches 125. In one embodiment, the partitioning is accomplished by selecting a subset of the input patches of particular interest. For example, only one or several patches could be selected.

A set of prototypical patches 140 includes patches of images of different prototypical faces. The use of prototypical as defined herein is conventional. A face is a prototype if the face of “an individual exhibits essential features of a particular type.” Each patch in the prototypical set 140 has one or more associated attributes 141 of the type. Examples of the set of attributes 141 are, but not limited to, gender, race, age, expression of a face, e.g., happy or sad.

Each patch in the set of input patches 125 is compared 130 with the set of prototypical patches 140. The prototypical patches that best match the input patches 125 are selected as a set of matching prototypical patches 135. Thus, for every input patch 125 the best matching prototypical patch 135 is selected from the prototypical patches 140.

The matching attributes 155 are retrieved 150 from the set of matching prototypical patches 135. The matching attributes are then used to determine 400 the set of (one or more) attributes 115 of the face in the input image 110.

Patches Comparison

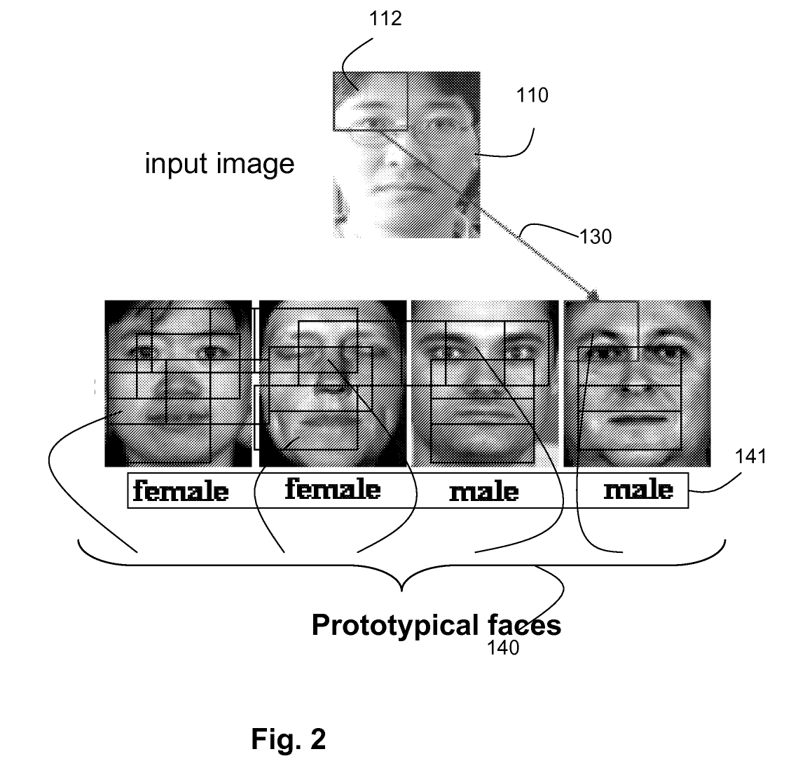

FIG. 2 schematically shows the comparison 130 of the patches 125 and 140 according to the embodiments of our invention.

This invention results from a realization that an unknown face can be characterized by combining parts of known faces, e.g., noses, eyes, and cheeks, taken from different people. More over, those parts of the faces generally carry the attributes of the entire face. For example, a patch 112 including a male eye is more likely to be found among images of other males than among images of females. Thus, if a patch 112 of an eye in the input image 110 matches the prototypical patch with “male” gender attribute 255, then with some degree of certainty, it can be said that the input image 110 was acquired from a male.

Similarly, other attributes of the input image 110, such as age and race can be determined by the comparison 130 with the set of prototypical patches 140 with known attributes 141.

Patches can be compared 130 in various ways. Some embodiments use sum of absolute differences of pixel values (L1 norm) or sum of squared differences of pixel values (L2 norm), or normalized cross correlation. Features extracted form the patches can also be compared. In this embodiment, a set of feature vectors, e.g., Gabor features, histogram of gradient features, or Haar-like features, are determined for all patches. Then, the feature vectors can be compared. Feature comparison can take less time than pixel-wise comparison. The features can also be designed to be attribute sensitive.

Image Partitioning

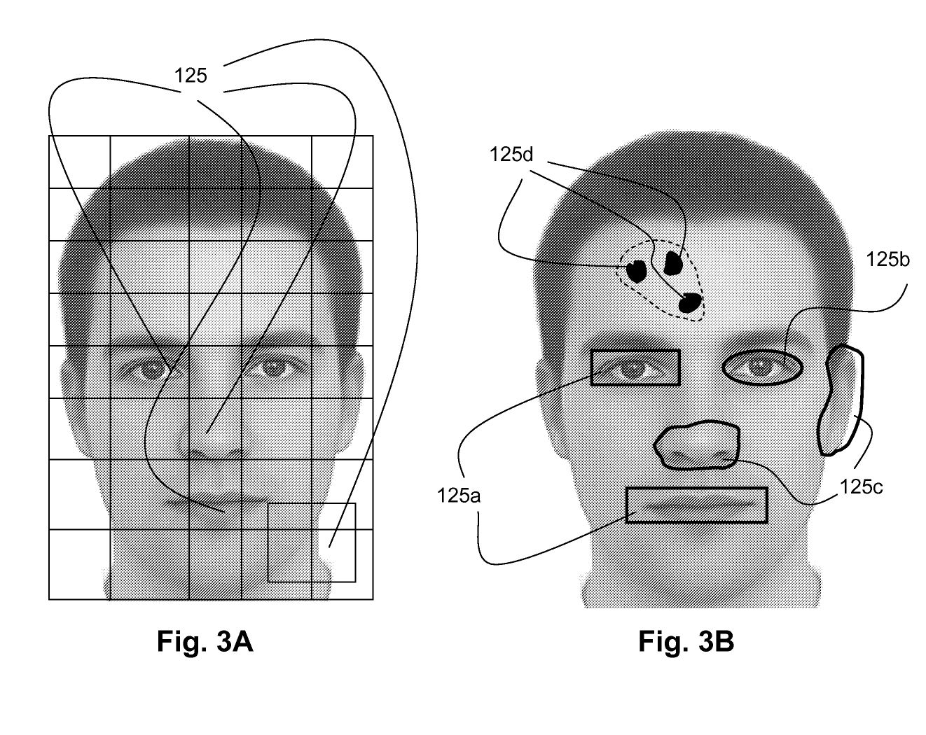

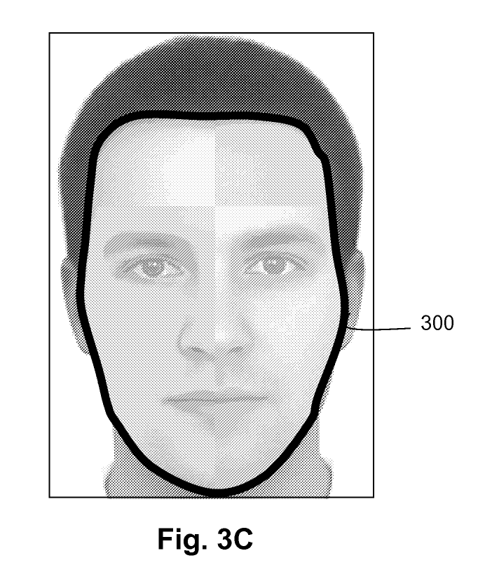

FIG. 3A shows an example partitioning 120 the input image 110 into patches 125 using a regular grid over the entire image. The patches 125 can have the same or different sizes, and overlap or not. The same partitioning scheme can be used to generate the prototypical patches 140.

The patches do not necessarily have a rectangular form. FIG. 3B shows other examples of patches. The patches can have a rectangular form 125a, an oval form 125b, or an arbitrary form 125c. Moreover, a patch 125 can be formed from disjoint pixels 125d. After the partitioning, an optimal set of patches that best characterize the attributes of interest can be selected for both the prototypical and input patches. For example, patches with strong features, e.g., eyes and mouth, can be retained, while featureless patches, e.g., the forehead or cheeks, can be discarded. The result is a set of prototypical and input patches that are optimal for determining a particular attribute of interest.

Image Aligning

To improve accuracy of the patches comparison 130, each image of a face, i.e., both the input image 110 and images used to select the prototypical patches 140, are aligned. Alignment can also be done on the patches. For example, images are normalized for scale, in-plane rotation and translation. In one embodiment of the invention image aligning is done using an aligning method that uses feature points, e.g., the centers of the eyes. A face detector and eye detectors can be used for this purpose to automate the alignment of the images. Given at least two feature points, the four parameters (scale, in-plane rotation angle, x offset and y offset) that map the feature points to some target feature locations can be computed by solving a linear least squares problem. The input image 110 can then be warped using bilinear interpolation and to yield fixed size aligned images. Cropping 300 can remove extraneous features such as hair as shown in FIG. 3C.

Prototypical Patches

Prototypical patches 140 can be acquired from different sources depending on the relevant attributes and application. For example, for the gender attribute, hundreds or thousands of prototypical face images can be obtained from collecting digital photographs from the World Wide Web or from photo collections. Attributes can be assigned manually or using computer vision techniques. An optimal set of prototypical patches can be selected as described above.

Image Attributes

After the set of matching prototypical patches 135 is determined, there are a number of ways that the attributes 155 can be used to determine attributes for the input image 110.

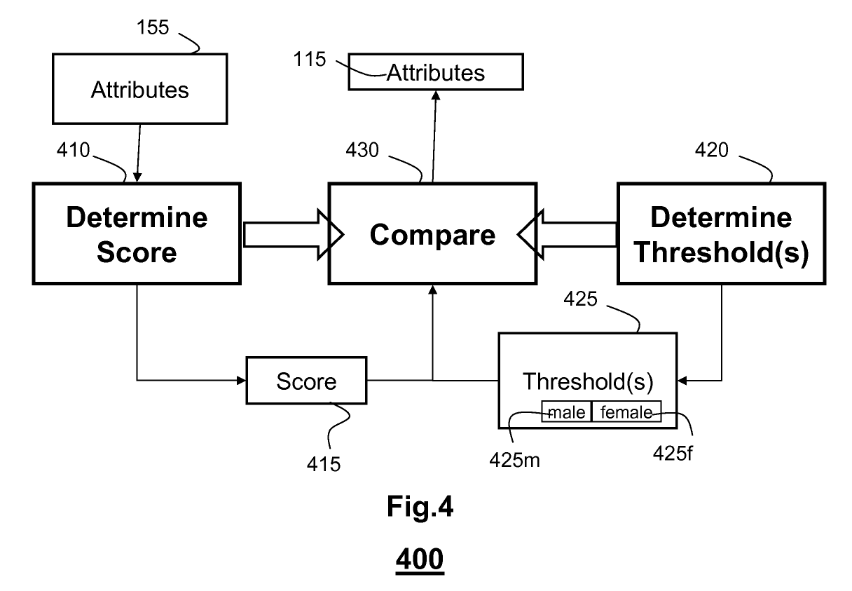

FIG. 4 shows one example to determine the attributes 115. In one embodiment, a score 415 is determined 410 as a percentage of the attributes 155 of the matching prototypical patches 135 that have a particular value. For example, if 60% of the matching patches 135 are male and 40% are female, then the score 415 is 60. After the image score 415 is determined, the score 415 is compared 430 with a threshold 425 to determine the attribute 115. For example, if the male score is 60, a gender attribute of the image 110 is “male” if the threshold 425m is less than 60 otherwise the attribute of the image 110 is “female”. This process can be repeated for each type of attribute.

The threshold 425 can be obtained from a receiver operating characteristic (ROC) curve that plots the percentage of mistakes on male faces versus mistakes on female faces using a test set of images of male and female faces for which a score has been computed using this method. If the threshold is set very low, then all faces will be predicted to be male, which will result in errors on all of the female faces but will have no errors on any of the male faces. Conversely, if the threshold is set very high then all faces will be predicted to be female, which will result in errors on all of the male faces but on none of the female faces. Thus, the optimal threshold 425 is in between those values and depends on how errors on males are weighted with respect to errors on females for a particular application. The ROC curve plots the overall error rate on the test set for each possible value of the threshold.

For an attribute such as age which can be a continuous value, an average or a weighted average of the attributes of all the matching prototypical patches can be used.

### EFFECT OF THE INVENTION

Unexpectedly and surprisingly, the relatively simple method according to the invention compares just patches, and not images as in the prior art. The method yields far superior results, when compared to conventional image classifier-based approaches. The results are more accurate and can concurrently determine multiple attributes.

In prior art classifier based techniques, this would require training multiple classifiers, and multiple passes over entire images. Thus, the method according to the embodiment of the invention is particularly suited for real-time computer vision applications.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

I claim:

1. A method for determining attributes of a face in an image, comprising:
partitioning an input image of a face into a set of input patches;
comparing each input patch with a set of prototypical patches to determine matching prototypical patches, wherein each matching prototypical patch is associated with at least one attribute forming a set of attributes associated with the matching prototypical patches; and
determining a set of attributes of the face in the input image according to the set of attributes associated with the matching prototypical patches.

2. The method of claim 1, further comprising:
acquiring the image of the face by a camera.

3. The method of claim 1, further comprising:
retrieving the attributes associated with the matching prototype patches.

4. The method of claim 1, wherein the comparison step further comprising:
extracting a feature vector from each input patch and each prototypical patch; and
comparing the feature vectors to determine matching prototypical patches.

5. The method of claim 1, wherein the partitioning step further comprising:
selecting an optimal set of input patches for the comparing.

6. The method of claim 1, wherein the input patches and the prototypical patches are obtained from aligned images.

7. The method of claim 1, wherein the set of prototypical patches is selected to be optimum.

8. The method of claim 1, wherein the determining further comprising:
determining a score according to the set of attributes associated with the matching prototypical patches; and
thresholding the score to determine the set of attributes of the face.

9. The method of claim 1, wherein the attributes in the set are selected from the group consisting of gender, age, expression of the face, pose, race and combinations thereof.

10. A method for determining attributes of a face in an image, comprising:
acquiring a patch of an image of a face;
comparing the patch with a set of prototype patches to determine a matching prototypical patch, wherein the matching prototypical patch has a set of associated attributes; and
determining a set of attributes of the face in the image according to the set of attributes associated with the matching prototypical patch.

11. A system for determining attributes of a face in an image, comprising:
a patch comparison module adapted for comparing a set of input patches of a an input image of a face with a set of prototypical patches to determine matching prototypical patches, wherein each matching prototypical patch is associated with at least one attribute forming a set of attributes associated with the matching prototypical patches; and
an attribute comparison module adapted for determining a set of attributes of the face in the input image according to a set of attributes associated with the matching prototypical patches.

12. The system of claim 11, further comprising:
an image partitioning module configured to partition the input image of the face into the set of input patches.
